(19) United States
(12) Patent Application Publication
(10) Pub. No.: US 2026/0292724 A1
(43) Pub. Date: Sep. 24, 2026

(54) METHODS, ARCHITECTURES, APPARATUSES AND SYSTEMS FOR SWITCHING BETWEEN NON-COVERAGE-ENHANCED AND COVERAGE-ENHANCED MODE

(71) Applicant: InterDigital Patent Holdings, Inc., Wilmington, DE (US)

(72) Inventors: Tao Deng, New York, NY (US); Jaya Rao, Montreal, CA (US); Umer Salim, Vallauris (FR); Moon IL Lee, Melville, NY (US); Paul Marinier, Brossard, CA (US)

(21) Appl. No.: 19/087,840

(22) Filed: Mar. 24, 2025

(51) Int. Cl. H04W 56/00; H04W 8/22; H04W 74/0833; H04W 76/20

(52) U.S. Cl. CPC H04W 56/0015; H04W 8/22; H04W 74/0833; H04W 76/20

(57) ABSTRACT

Procedures, methods, architectures, apparatuses, systems, devices, and computer program products related to cell access including, for example switching between cell access modes, are described. One method may include determining, based on a synchronization signal block associated with a second mode, to access a cell in a first mode, receiving system information that indicates first cell access information associated with the first mode, sending a transmission according to the first cell access information to indicate that the WTRU is capable of both the first and second modes, receiving second cell access information associated with the second mode, determining that the second mode can be used, and sending, to a network node, information indicating that the second mode can be used.

### FIELD

Example embodiments described in the present disclosure are generally directed to the fields of communications, software and/or encoding, including, for example, to methods, architectures, apparatuses, systems related to cell access including, for example, switching between cell access modes.

### BACKGROUND

Initial cell access by a user equipment (UE) is based on new radio (NR) synchronization signal block (SSB) transmission that includes periodically transmitted synchronization signal blocks (SSBs). A SSB includes a primary synchronization signal (PSS), secondary synchronization signal (SSS) and physical broadcast channel (PBCH). The physical layer sequences used for PSS and SSS provide a UE with a physical cell identity (PCI) of the cell. The PBCH can carry master information block (MIB) and provide necessary system information for a UE to acquire cell access.

### SUMMARY

An embodiment may include a wireless transmit/receive unit (WTRU) including circuitry, including any of a processor and transceiver, configured to determine to access a cell in a first mode, based on a synchronization signal block associated with a second mode; detect a synchronization signal block associated with the first mode; receive system information associated with the first mode, where the system information indicates first cell access information associated with the first mode; send a transmission according to the first cell access information, where the transmission indicates that the WTRU is capable of both the first and second modes; receive second cell access information associated with the second mode; determine that the second mode can be used, based on measurements associated with the second cell access information; and send, to a network node, information indicating that the second mode can be used.

An embodiment may include a method, implemented by a wireless transmit/receive unit (WTRU). The method may include determining to access a cell in a first mode, based on a synchronization signal block associated with a second mode; detecting a synchronization signal block associated with the first mode; receiving system information associated with the first mode, where the system information indicates first cell access information associated with the first mode; sending a transmission according to the first cell access information, where the transmission indicates that the WTRU is capable of both the first and second modes; receiving second cell access information associated with the second mode; determining that the second mode can be used, based on measurements associated with the second cell access information; and sending, to a network node, information indicating that the second mode can be used.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 is an example diagram illustrating the NR initial access procedures;

FIGS. 3A-3B illustrate an example of initial cell access procedures for coverage-enhanced cell access mode, according to an embodiment; and

FIGS. 4A-4C illustrate a flow diagram of a method, according to some embodiments; and

FIG. 5 illustrates a flow diagram of a method, according to some embodiments.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

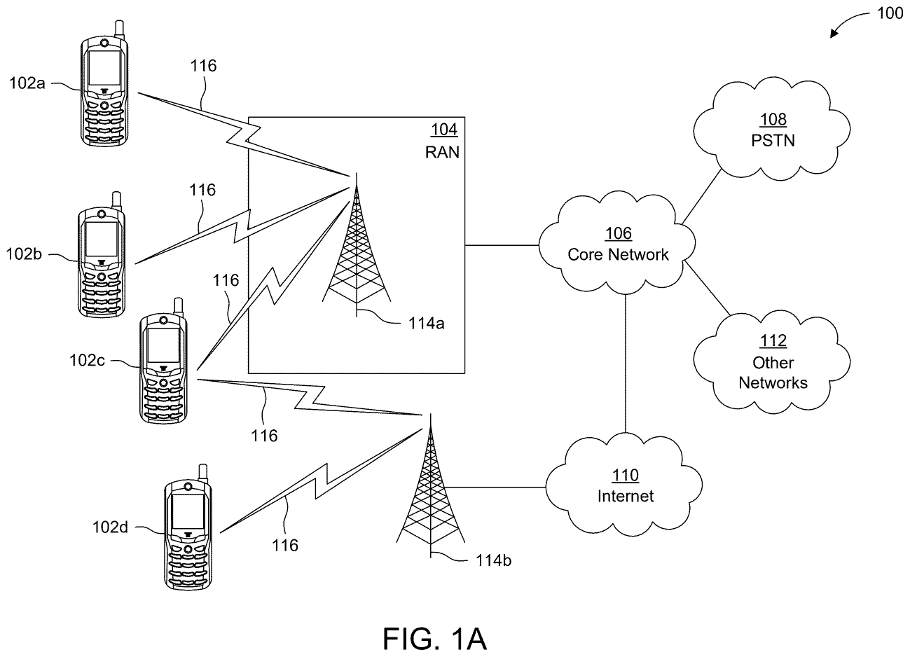

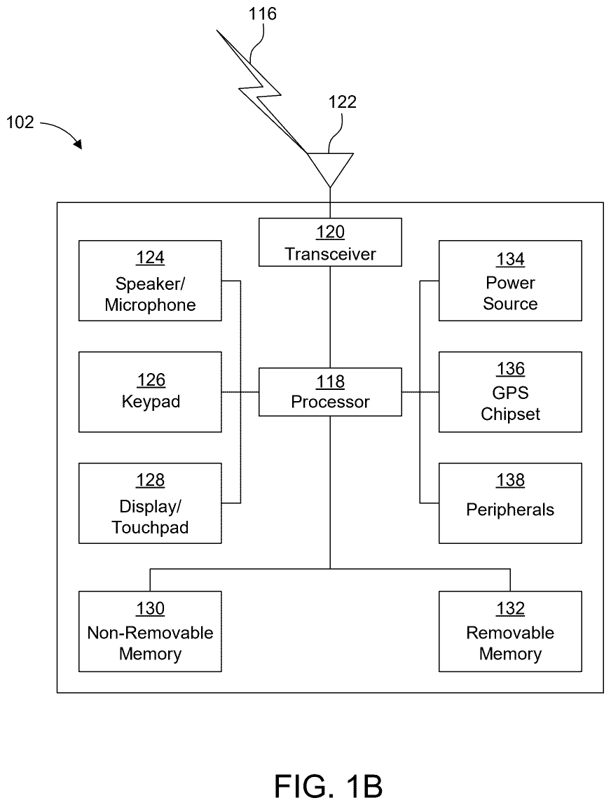

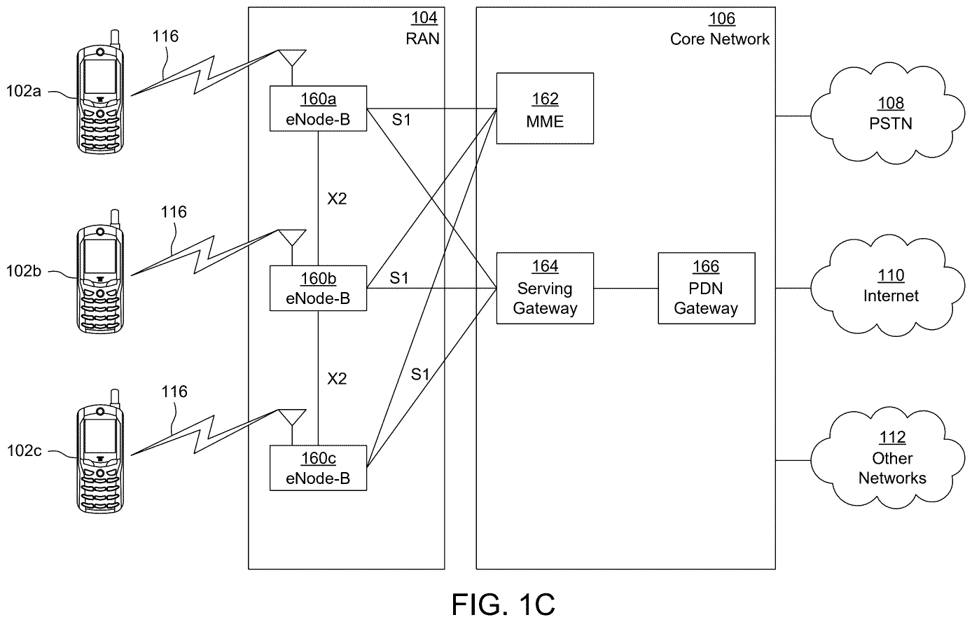

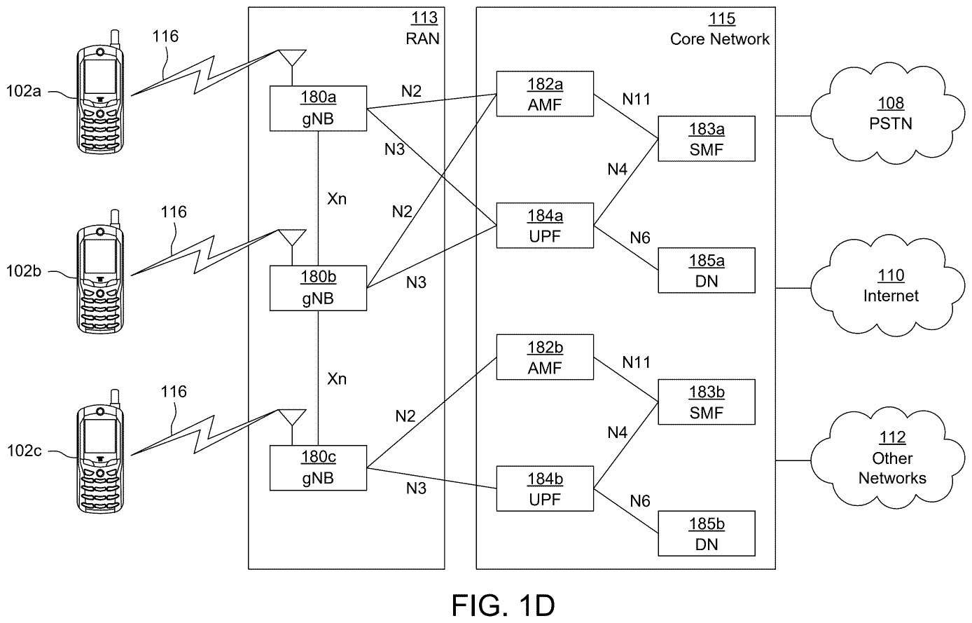

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d, or any other WTRU mentioned or described herein, may be interchangeably referred to as a UE or vice versa.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Embodiments disclosed herein are representative and do not limit the applicability of the apparatus, procedures, functions and/or methods to any particular wireless technology, any particular communication technology and/or other technologies. The term network in this disclosure may generally refer to one or more base stations or gNBs or other network entity which in turn may be associated with one or more Transmission/Reception Points (TRPs), or to any other node in the radio access network.

It is noted that, throughout example embodiments described herein, the terms “base station”, “seving base station”, “RAN,” “RAN node,” “Access Network,” “NG-RAN,” “gNodeB,” and/or “gNB” may be used interchangeably to designate any network element such as, e.g., a network element acting as a serving base station. It should be understood that embodiments described herein are not limited to gNBs and are applicable to any other types of base stations.

Initial cell access is based on new radio (NR) synchronization signal block (SSB) transmission that includes periodically transmitted synchronization signal blocks (SSBs). A SSB includes a primary synchronization signal (PSS), secondary synchronization signal (SSS) and physical broadcast channel (PBCH). SSBs can be transmitted at a frequency location within a NR carrier pre-configured by global synchronization channel number (GSCN) and the frequency interval between GSCNs is pre-defined as sync raster.

The physical layer sequences used for PSS and SSS provide a WTRU with a physical cell identity (PCI) of the cell. The PBCH can carry master information block (MIB) and provide necessary information for a WTRU to receive system information block 1 (SIB1) transmitted in the cell in order to acquire cell access.

The information necessary to receive SIB1 transmission can include, for example, physical downlink shared channel (PDSCH) demodulation reference signal (DMRS) position, Sub-Carrier Spacing (SCS), physical downlink control channel (PDCCH) resource configuration, cell-baring information, etc. A SSB including a PBCH associated with SIB1 transmission and thus leading to cell access information acquisition is referred to as Cell-Defining SSB (CD-SSB). A CD-SSB is transmitted (e.g., always transmitted) in a Primary Cell (PCell) on a GSCN. A SSB not associated with SIB1 can also be transmitted and is referred to as Non-Cell-Defining SSB (NCD-SSB).

The SIB1 information includes random access configuration for a WTRU to perform a Random Access procedure to request and perform a radio resource control (RRC) connection establishment. A WTRU can enter RRC CONNECTED state and receive RRC configurations to further access the cell and perform data operation within the cell.

It is being considered for 6G radio access technology (RAT) to be able to support diverse device types including, for example, smart phone, customer primary equipment (CPE), IoT devices, reduced capability (RedCap) devices, wearable devices, etc. While most of the device types are already supported in 5G NR, a main category of IoT devices of low power wide area (LPWA) devices such as meters and sensors are not supported. The operation of these devices is limited by narrow bandwidth (e.g. 200 kHz) and low battery consumption and, as a result, the design principles for the air interface to support these devices are considerably different from that for other UE types.

In 4G LTE, Machine Type Communication (MTC) and Narrow Band-IoT (NB-IoT) systems are designed and implemented as a separate new RAT to support the LPWA devices. The physical layer signaling and procedure, channel structure and transmission schemes are vastly different from the LTE baseline framework. The deployment and operation based on LTE-based MTC and NB-IoT continue to be used in 5G networks. However, as a 6G design consideration, a singular RAT with a unified design to support all device types is important, including LPWA-like devices. This unified design can potentially provide additional path(s) to camp on and operate within a cell for devices with advanced capability.

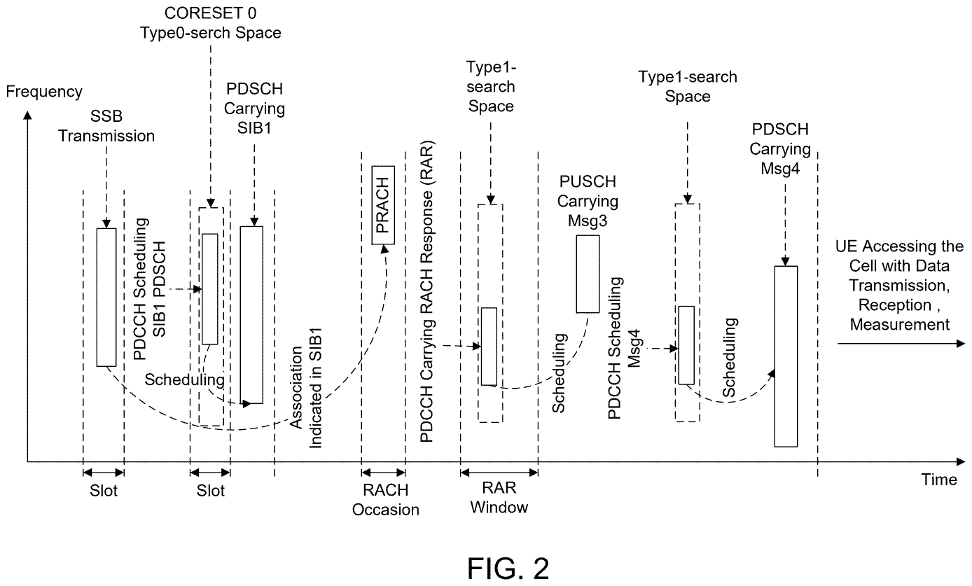

In NR, a WTRU or device has a single path to access a cell through performing sequentially a set of steps including cell search, PBCH decoding to acquired MIB, PDCCH (CORESET 0/Type-0 common search space) and PDSCH decoding to acquire SIB1, random access procedure (PRACH) and RRC connection establishment. FIG. 2 illustrates an example diagram depicting the NR initial access procedures. The involved signaling/channels and procedure for each step of the path, e.g., SSB, PBCH, PDCCH (CSS 0), PDSCH transmission, as illustrated in FIG. 2, has only one option regardless of WTRU or device types or coverage scenarios. For example, SSB is 20 RB wide over 4 symbols, singular PBCH content, CORESET 0 resource allocation and associated PDSCH in one slot only, fixed SI update window, etc.

As illustrated in the example of FIG. 2, the singular path to the cell access and operation within the cell is designed toward a coverage requirement that do not apply to certain type of WTRUs, e.g., the devices supporting a bandwidth narrower than the SSB and/or CORESET 0 bandwidth. In addition, when a WTRU capable of performing the cell access finds itself in a poor coverage situation (e.g. due to high interference and/or low signal level), it will declare radio link failure and lose the connectivity. Furthermore, a WTRU may benefit from accessing a cell in a way that consumes less battery power. This singular path-based cell access is thus not flexible and enhancements can be considered to provide additional means to access a cell.

Therefore, some example embodiments described herein can address at least the problem of how to enable flexible paths to access a cell for WTRUs with reduced capability, WTRUs in a poor coverage and/or WTRUs with limited battery consumption.

As will be discussed in detail below, in an embodiment, a WTRU may perform initial cell access in (or according to) a certain mode, such as a coverage-enhanced (CE)/non-coverage-enhanced (NCE) mode, according to a set of conditions and/or events. These conditions and/or events may include, for example, when SSB associated with a cell access mode is absent or below a threshold, when it is indicated in an SSB, when it is associated with NES state or WTRU power saving status, etc.

As will be discussed in detail below, in an embodiment, a WTRU may apply cell access mode-specific information in initial cell access, e.g., regarding CORESET 0 repetition (indicated in MIB) and RACH repetition and frequency hopping.

As will be discussed in detail below, in an embodiment, a WTRU may indicate and/or request (e.g., using RACH, PUCCH, WUS, etc.) to receive MIB and SIB1 information of a cell access mode that is different from the mode the WTRU uses to acquire initial access.

As will be discussed in detail below, in an embodiment, a WTRU may switch between cell access modes, e.g., between CE and NCE access mode, in CONNECTED state based on a further set of conditions or events, such as network indication, cell measurement, WTRU power saving state, NES state, etc.

As mentioned above, a single 6G RAT may enable two modes of cell access (e.g., a first mode and a second mode). As used herein, the two modes may be referred to as coverage-enhanced (CE) mode and non-coverage enhanced (NCE) mode; however, it should be understood that these modes may be referred to using different terminology. The modes are associated with a set of different configurations related to, for example, frame structure (SS over multiple symbols), transmission scheme (repetition), channel bandwidth (BWP), channel format (SS type, PRACH format), timing relationship (RAR window length, PDCCH/PDSCH k value), etc. For example, according to certain embodiments, a WTRU capable of both modes can access a cell in CE mode in a poor coverage or in a power saving state and switch to NCE mode when conditions change. In an embodiment, the switch of cell access mode prompts the WTRU to apply all associated configurations at once.

According to certain embodiments, a WTRU may be configured to determine to access a cell in a first mode, e.g., a coverage-enhanced (CE) mode. For example, the WTRU may determine to access the cell in the CE mode when a SSB associated with a second mode, e.g., a non-coverage-enhanced (NCE) mode, is not detected or is below a threshold. In an embodiment, the WTRU may detect a SSB associated with CE mode and may receive PBCH (e.g., MIB) and/or system information (e.g., SIB1) associated with CE mode. For example, the system information (e.g., SIB1) may provide first cell access information, such as RACH parameters for CE mode.

In some embodiments, the WTRU may send a transmission (e.g., a RACH or other uplink transmission) according to the first cell access information. For example, a portion or aspect of the transmission may indicate that the UE is capable of both CE and NCE modes and/or may indicate that the WTRU is camping on a cell in CE mode.

According to certain embodiments, the WTRU may receive (or send a request and receive) second cell access information associated with NCE mode. The second cell access information may include any one or more of non-coverage-enhanced SSB, CORESET, CSI-RS information, RACH configuration, MIB, etc.

In some embodiments, the WTRU may measure the NCE mode SSB/CSI-RS based on the configuration indicated in the received second cell access information and/or may determine that NCE-mode can be used (e.g., when the measurement is above a threshold). According to an embodiment, the WTRU may send an indication to the network to indicate that NCE-mode can be used.

The method(s) described herein, such as the method described above, enables a WTRU of reduced capabilities to access a cell in a NCE mode and a WTRU capable of accessing a cell in either CE or NCE mode to select a path to acquire cell access (e.g., enter RRC CONNECTED) in a poor coverage scenario or in a power saving state. Example embodiments also provide a benefit of configuration signaling overhead reduction. Instead of network transmitting individual re-configurations regarding, e.g., CORESET, SS, PDSCH, PDCCH, CSI, etc., a cell access coverage mode re-configuration and/or switch can trigger the WTRU to apply previously received configurations corresponding to the switched-to cell access mode.

In some embodiments, a WTRU may determine, be (pre-)configured, be (pre-)defined and/or be indicated to operate in a cell according to a cell access mode. A WTRU may perform any one or more of the following specific to a cell access mode: detect and synchronize with one or more synchronization signals (SS) in a cell and acquire a physical cell ID (PCID), receive an initial cell access broadcast transmission (e.g. in a PBCH) to acquire initial cell access information, receive further cell access information (e.g. in SIB1 carried in a PDSCH transmission) based on PBCH information, initiate a random access procedure (including sending PRACH, monitoring RAR, sending Msg3 and receiving Msg4) to establish a RRC connection with the cell, perform bandwidth part (BWP) adaptation, monitor one or more PDCCH(s) to receive Downlink Control Information (DCI) format(s) that may carry DL and/or UL data channel scheduling information, receive downlink (DL) data in one or more PDSCH(s) according to received DL data channel scheduling information in a PDCCH, receive cell-specific DL data (e.g., System Information) and/or UE-specific DL data, transmit uplink (UL) data in one or more PUSCH(s) according to received UL data channel scheduling information in a PDCCH, perform DL measurement and reporting including channel state information (CSI) measurement and/or RRM measurement, transmit UL control information (UCI) including e.g., HARQ, CSI and/or SR in one or more PUCCH(s), transmit UL sounding reference signal (SRS), perform UL power control for PUCCH, PUSCH and/or SRS transmission, and/or perform beam failure recovery (BFR) and/or radio link monitoring (RLM).

According to certain embodiments, a cell access mode may be associated with a specific cell coverage. A cell coverage may be defined and/or indicated by one or more metric(s), e.g., link budget and/or maximum coupling loss of X dB. In one example, a WTRU may be (pre)defined and/or (pre)configured with a set of signal(s), channel(s), function(s) and/or procedures for operation in a cell coverage defined by a MCL of X dB, e.g., a default, normal and/or non-coverage-enhanced mode (referred as NCE mode in this document). For example, the value of X may, e.g., be 140 dB. Within this cell coverage, a WTRU may achieve a pre-defined and/or pre-configured operation requirement, e.g., PDCCH BLER, PDSCH BLER, SSB sensitivity level, etc. at a received signal level of (gNB TX power—X) dBm. A WTRU accessing a cell based on this cell coverage may be referred to as accessing a cell in a non-coverage-enhance (NCE) mode.

In another example, a WTRU may be (pre)defined and/or (pre)configured with an additional set of signal(s), channel(s), function(s) and/or procedures for operation in a cell coverage defined by a MCL of X+Y dB. For example, the value of Y may, e.g., be 20 dB. Within this cell coverage, a WTRU may achieve a pre-defined and/or pre-configured operation requirement, e.g., PDCCH BLER, PDSCH BLER, SSB sensitivity level, etc. at a received signal level of (gNB TX power—X−Y) dBm. A WTRU accessing a cell based on this said cell coverage may be referred to as accessing a cell in a coverage-enhanced (CE) mode.

In a further example, a WTRU may be (pre)defined and/or (pre)configured with a set of cell access modes corresponding to a set cell coverage metrics, e.g. MCLs of (X, X+Y, . . . , X+nY) dB where n may be the number of total cell access modes. Cell access mode 1 may correspond to a NCE cell coverage defined by a MCL of X dB. Cell access mode 2 may correspond to a first CE cell coverage defined by a MCL of (X+Y) dB. Cell access mode 3 may correspond to a second CE cell coverage defined by a MCL of (X+2xY) dB and so on. A WTRU may be (pre)defined and/or (pre)configured with a set of signal(s), channel(s), function(s) and/or procedures for operation in a cell coverage in NCE and each CE mode.

The above-discussed sets of signal(s), channel(s), function(s) and/or procedures for operation in a cell coverage may be referred to as associated with a cell access mode. Certain example embodiments described herein may be based on two cell access modes, i.e. NCE and CE modes, for purpose of clarity and may readily applied to a set of more than two cell access modes.

Some embodiments may include cell access in NCE and/or CE modes, which may include SSB detection and/or reception. For example, a WTRU may detect and receive SSB (pre)configured for CE mode (CE SSB) and/or NCE mode (NCE SSB). The CE SSB and NCE SSB may be determined based on one or more of the following component(s) and/or properties: sub-carrier spacing (SCS) of SSB; primary synchronization signal (PSS) and secondary synchronization signal (SSS) sequences; physical layer identity (PCID); frequency location of the SSB (e.g., GSCN and sync raster); bandwidth of the SSB; time duration of the PSS, SSS and PBCH in the SSB; time domain multiplexing pattern of PSS, SSS and PBCH in the SSB; periodicity of the SSB; DMRS for PBCH transmission; PBCH repetition; and/or PBCH information.

With respect to sub-carrier spacing (SCS) of SSB, NCE SSB may apply more than SCS in one carrier, e.g., 15 kHz or 30 kHz in a FR1 carrier and 60 kHz or 120 kHz in a FR2 carrier. A WTRU may perform a blind detection of SCS during SSB detection in a carrier. CE SSB may apply one (pre)configured SCS for a carrier, e.g., 15 kHz in a FR1 carrier. CE SSB SCS may indicate the same SCS used for data operation in the cell, e.g., the SCS used for PDCCH, PDSCH, RS, PUCCH, PUSCH transmission. NCE SSB SCS may not be the same as SCS used for data operation within the cell.

With respect to primary synchronization signal (PSS) and secondary synchronization signal (SSS) sequences, in one example, CE PSS may be based on a single PSS sequence and a multitude of SSS sequences. NCE PSS may be based on more PSS sequences (e.g. three) and fewer SSS sequences. CE SS and NCE SS may use different sequence types including e.g., Zadoff Chu (ZC) sequence, M sequence and/or Gold sequence. CE PSS and/or SSS sequence length may be smaller than NCE PSS and/or sequence length. In another example, a CE SSS may indicate a number of Lease Significant Bits (LSBs) of SFN.

With respect to physical layer identity (PCID), a WTRU may determine a physical layer cell identity (PCI) based on the index(es) of detected and received PSS and SSS. In one example, a WTRU may be (pre)configured with different equation for PCID determination based on the index of PSS and SSS sequence used for NCE and CE SSB. In another example, CE PCID may be based on SSS sequence index.

With respect to frequency location of the SSB (e.g., GSCN and sync raster), a SSB may be located at a frequency location denoted by a (pre)configured GSCN (Global Synchronization Channel Number) and/or associated sync raster (i.e. frequency interval between GSCN) specific for coverage-enhanced cell access. There may be a set of (pre)defined and/or (pre)configured GSCNs within a carrier.

In one example, a WTRU may be (pre)configured with a GSCN set for NCE mode and another set for CE mode. A WTRU may determine to scan the set of (pre)configured GSCNs during initial access according to the cell access mode.

In another example, a WTRU may be (pre)configured with a set of NCE GSCNs and/or associated sync raster and a frequency offset related to the corresponding CE mode GSCNs in the same carrier. A WTRU may thus perform a detection of a CE SSB at a frequency location based on the sum of the (pre)configured frequency offset and the frequency location denoted by a NCE GSCN. In another example, a WTRU may determine the frequency location of the NCE SSB located on or off the GSCN sync raster for example, based on the frequency offset information indicated in the CE SSB (e.g. PBCH payload and/or MIB associated with CE SSB).

In one example, a WTRU may pre-configured with the frequency locations for CE SSBs and UE may be configured to determine the frequency location of NCE SSBs based upon pre-configuration and an indication from one of the detected CE SSBs.

In another example, a WTRU may pre-configured with the frequency locations for NCE SSBs and UE may be configured to determine the frequency location of CE SSBs based upon pre-configuration and an indication from one of the detected NCE SSBs.

With respect to bandwidth of the SSB, CE PSS, SSS and PBCH may be transmitted within a same (pre)configured frequency bandwidth including, e.g., a number of sub-carriers and/or RBs. In one example, the CE SSB bandwidth may be determined based on a minimum WTRU capability. The bandwidth of CE SSB may a (pre)configured portion of the NCE SSB, e.g., ½, ¼ or ⅛. In another example, the bandwidth of CE SSB may be limited to a specific number of PRBs or frequency span in MHz while the bandwidth of NCE SSB may be a different specific number of PRBs or frequency span in MHz.

With respect to time duration of the PSS, SSS and PBCH in the SSB, a NCE PSS, SSS and/or PBCH transmission may occupy one or more symbols, e.g. PSS and SSS each over one symbol and PBCH over two symbols. A CE PSS, SSS and/or PBCH transmission may occupy one or more sub-slot (7 symbols) and slot (14 symbols).

With respect to time domain multiplexing pattern of PSS, SSS and PBCH in the SSB, in one example, NCE PSS, SSS and PBCH may be time multiplexed over consecutive symbols within a slot. CE PSS, SSS and PBCH may be transmitted within respective sub-slot and/or slot in a radio frame denoted by a SFN. The index of the sub-slot and/or slot may be (pre)configured and may be consecutive or non-consecutive.

With respect to periodicity of the SSB, the NCE SSB may be transmitted in one of a set of (pre)configured periodicities, e.g., 20 ms, 40 ms, 80 ms and/or 160 ms. A WTRU may blind detect a NCE SSB periodicity. CE SSB may be transmitted based on a singular (pre)configured periodicity. In one example, NCE PSS and PBCH may be transmitted in every radio frame (i.e. periodicity of 10 ms) and NCE SSS may be transmitted every two radio frames to indicate odd or even frame number (i.e. periodicity of 20 ms).

In another example, a WTRU may be predefined or (pre)configured with the time domain relation between the CE SSB and NCE SSB, where the time domain relation may correspond to any of periodicity scaling and time offset. For example, for a periodicity scaling value of 2, the WTRU may determine the NCE SSB bursts to be transmitted with one of periodicity 40 ms, 80 ms, 160 ms etc., when the periodicity of CE SSBs may be transmitted with one of a periodicity 20 ms, 40 ms, 80 ms, etc. For example, a time offset (e.g. in terms of number of symbols, slots, half-frame index, SFNs) may be defined with respect to an absolute reference time instance (e.g. reference SFN) or a relative reference time instance (e.g. start/end symbol of the first/last active SSB index in a CE SSB burst). In this case, the WTRU may determine the time location of an NCE SSB burst based on that of the CE SSB burst and the time offset.

With respect to DMRS for PBCH transmission, NCE PBCH may be (pre)configured with associated PBCH DMRS. The NCE PBCH DMRS may be time domain duplexed with the PBCH and occupy the same bandwidth as the PBCH. The NCE PBCH sequency may apply Gold sequence and scrambled with a sequence initialized with PCID. A multitude of NCE PBCH DMRS sequences may be (pre)configured to indicate, e.g., the SSB index. A WTRU may thus blind detect a NCE PBCH sequence and determine a SSB index based on the detected NCE PBCH DMRS sequence.

CE PBCH may be (pre)configured to be demodulated based on a DL RS common for PDCCH decoding, PDSCH decoding and/or a CSI measurement. A CE DL RS may be transmitted according to a (pre)configured pattern in time and frequency domain. The time domain pattern may be symbol, sub-slot and/or slot allocated for the CE DL RS transmission. The associated frequency domain pattern may be sub-carriers and/or RBs allocated for the CE DL RS transmission. A CE DL RS sequence may be a (pre)configured ZC sequence scrambled with a sequence initialized with PCID. A WTRU may receive a CE DL RS to estimate the channel and decode PBCH without blind detection.

With respect to PBCH repetition, NCE PBCH may be repeated based on the SSB periodicity as discussed above, e.g., repeated once in each SSB period. CE PBCH may be repeated according to a (pre)configured repetition rate, e.g., the same CE PBCH may be repeated once in each radio frame for a (pre)configured number of radio frames, e.g. 64 or 125 frames. A WTRU may accumulate decoded PBCH soft symbols for combining over the (pre)configured number of CE PBCH transmissions.

With respect to PBCH information, in one example, NCE PBCH may have a large payload and indicate a minimum set of Master Information Block (MIB) information including SFN, cell access permission information (e.g. cell barred), intra-frequency cell re-selection information. In addition, NCE PBCH may include MIB information specific to NCE mode, e.g., sub-carrier spacing (SCS) for data operation in the cell, DMRS type associated with DL and/or UL data transmission, configuration for CORESET 0 and Type-0 common search space (CSS) for PDCCH scheduling SIB1 transmission, and SSB identified (e.g., a SSB index). The CORESET 0 configuration may include time and frequency resource of CORESET 0 and Type-0 CSS configuration may indicate the symbols and periodicity for PDCCH monitoring.

CE PBCH information may have a small payload and include the same minimum set of MIB information common for both CE and NCE mode cell access and additional information specific to CE mode. In one example, CE PBCH may indicate above-mentioned common MIB information such as e.g., SFN, cell access permission information (e.g. cell barred) and/or intra-frequency cell re-selection information. The additional information in CE PBCH may indicate a repetition pattern of CORESET 0 and/or Type-0 CSS.

Certain embodiments may include SIB1 acquisition. For example, in an embodiment, a WTRU may acquire SIB1 in a PDSCH scheduled by a PDCCH received in CORESET 0/Type-0 CSS. The CE and NCE SIB1 acquisition may be determined based on one or more of the following component(s) and/or properties: PDCCH monitoring in CORESET 0 and Type-0 CSS to receive PDSCH carrying SIB1, and/or SIB1 information.

In one example, as shown in FIG. 2 for NCE mode, a CORESET 0 and Type-0 CSS may be associated with a NCE SSB based on (pre)configured multiplexing pattern. A WTRU may decode a PDCCH and receive the scheduled PDSCH carrying NCE SIB1 within a SSB period. The PDCCH and PDSCH repetition may be the same as the SSB period. The NCE SIB1 may be updated every 160 ms. A WTRU may receive a NCE DCI format for NCE SIB1 scheduling, e.g. DCI 1_0.

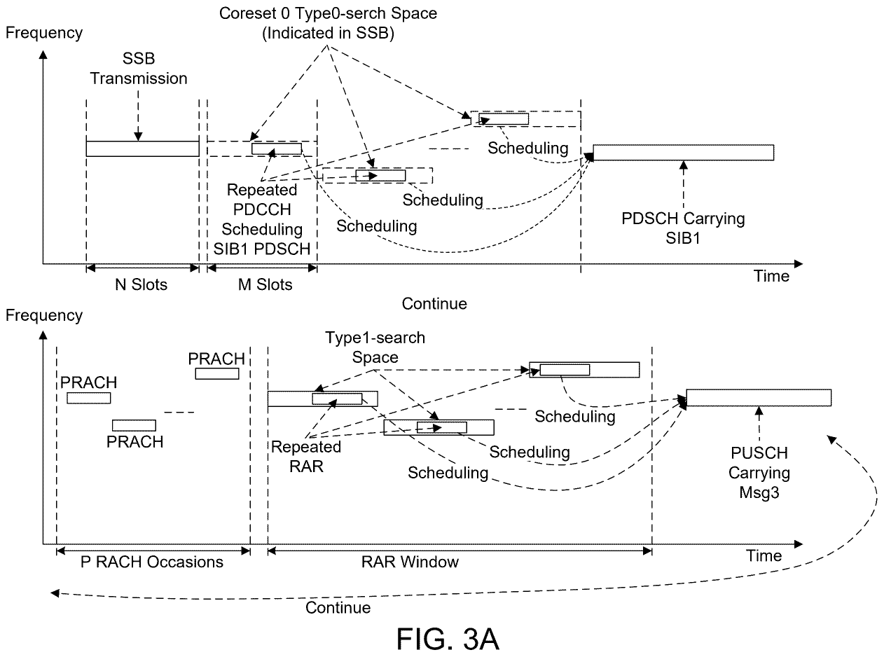

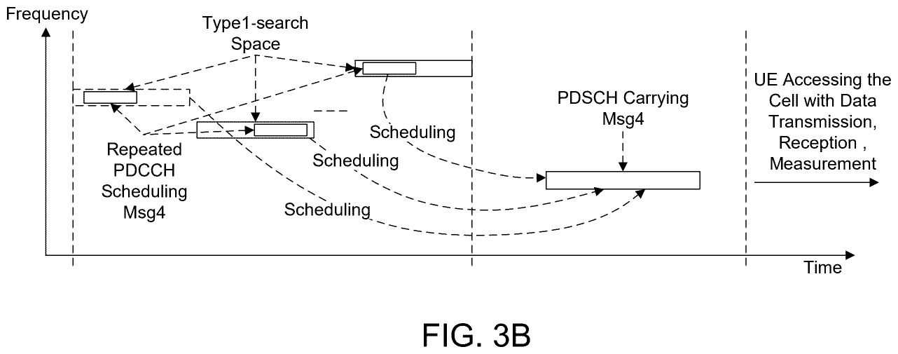

FIGS. 3A-3B illustrate an example of initial cell access procedures for coverage-enhanced cell access mode, according to an embodiment. As shown in the example of FIGS. 3A-3B, a repetition for CORESET 0 and Type-0 CSS may be indicated in CE PBCH to enable PDCCH repetition. Each repeated COREST 0 may have identical bandwidth. The CORESET 0/Type-0 CSS repetition pattern may indicate the center frequency of multiple CORESET 0/Type-0 CSS and the consecutive symbols, sub-slots and/or slots within one or more radio frames.

A WTRU may determine a repetition pattern based on indication in the CE PBCH and the radio frame number. In this case, the CORESET 0 and associated Type-0 CSS may have different repetition pattern in each radio frame, e.g., the frequency locations of repeated CORESET 0 may be different in each frame according to a (pre)configured pattern. In one example, a WTRU with limited bandwidth may retune the center frequency to monitor difference repeated CORESET 0 and associated Type-0 CSS.

A WTRU may decode a CE DCI format for CE SIB1 scheduling based on the PDCCH transmission repeated in each indicated CORESET 0/Type-0 CSS. A CE SIB1 may have a longer update periodicity, e.g. 1280 or 2560 ms.

SIB1 information may include at least configurations for RACH transmission, RAR monitoring, DL and UL BWP, common search space (e.g. Type-1 CSS), UE-specific search space (USS), DL and UL BWP, CSI-RS configuration, PDSCH transmission and/or PUSCH transmission. CE SIB1 configuration may include different parameters compared to the NCE SIB1 configuration. The CE-specific parameters may enable a WTRU to reduce memory storing, CPU processing and/or battery consumption.

The difference between the CE and NCE configuration may include any one or more of the following.

The CE SI window for other SIB transmission may be longer than NCE SI window. SI content may be identical within a SI window. Thus, a UE accessing a cell in CE mode may be (pre)configured to receive more repetitions of SI transmissions within the longer SI window.

CE RAR window length may be longer than NCE RAR window. A WTRU in CE mode may receive a (pre)configured number of repetitions of RAR (e.g., carrier in a PDCCH) within the longer RAR window.

CE may have RAR repetition within RAR window. NCE mode may have one RAR transmission within a RAR window.

CE PRACH transmission may have a smaller bandwidth than NCE PRACH. In one example, a WTRU may (pre)configured to transmit a preamble using one, three, six and twelve sub-carriers. A WTRU may determine the number of sub-carriers based on the repetition factor of the CORESET 0/Type-0 CSS.

CE PRACH transmission may be based on repetition pattern with frequency hopping corresponding to a RAR reception. NCE PRACH transmission may not use the pattern-based repetition.

CE CORESET may have a smaller number of RB and more symbols that NCE CORESET. In one example, a CE CORESET may consist of a sub-slot (7 symbols) or a slot (14 symbols) and a NCE CORESET may use up to 3 symbols. In another example, a CE CORESET may occupy a number of sub-carries (e.g., 6, 12, 24) and a NCE CORESET may be based on one or more RB(s).

CE CSS (e.g. Type-1 CSS for RAR/Msg3/Msg4 scheduling) and USS may be repeated based on (pre)configured repetition pattern. A WTRU may be indicated with the repetition configuration in PBCH and SIB1 configurations.

CE DCI formats for monitoring in USS may have a smaller payload size. Number of HARQ processes may be smaller for CE mode, e.g. 1 or 2 per carrier and 8 or 16 for NCE mode. The maximum transport block size (TBS) for PDSCH and PUSCH transmissions in CE mode may be limited to a (pre)configured value.

CE PDSCH and/or PUSCH may apply channel coding with lower processing, e.g., based on convolutional coding. NCE PDSCH and/or PUSCH may use LDPC-based channel coding. CE PDSCH and/or PUSCH may apply, e.g., pi/2 BPSK and QPSK modulation and NCE PDSCH and/or PUSCH may apply QPSK and QAM modulation.

CE scheduling delay, e.g. the time between PDCCH and corresponding HARQ transmission, the time between PDCCH and the scheduled PDSCH transmission and the time between PDCCH and scheduled PUSCH transmission may be based on a number of sub-slots, slot, sub-frames and/or frames. The corresponding NCE parameters may be based on a number of symbols.

CE UL transmission may apply DFT-s-OFDM waveform and NCE UL transmission may use DFT-S-OFDM and CP-OFDM waveforms. CE CSI measurement may be performed based on DL common RS transmissions. NCE CSI measurement may be based on (pre)configured CSI-RS transmissions.

In some embodiments, a WTRU may perform a RRC connection establishment. For example, the RRC connection establishment may be based on CE or NCE cell access mode. The CE and NCE RRC establishment may be determined based on one or more of the following component(s) and/or properties: PRACH transmission, and/or PDCCH monitoring for scheduling of RAR, Msg3 transmission and Msg4 reception in Type-1 CSS.

According to an embodiment, NCE PRACH transmission may be transmitted within a RO associated with a NCE SSB. The frequency resource of a NCE PRACH transmission may include a number of RBs, e.g. 12 RBs. A WTRU may perform a power ramping of a preamble (i.e. PRACH) when RAR may not be received within a (pre)configured RAR window.

In one example, as shown in FIGS. 3A-3B, a CE PRACH transmission may have repetition pattern associated with CORESET 0/Type-0 CSS repetition pattern. A WTRU may transmit preamble(s) using a (pre)configured number of sub-carriers (e.g., 1, 3, 6 or 12 sub-carriers) according to the CE RACH repetition pattern.

An embodiment may include PDCCH monitoring for scheduling of RAR, Msg3 transmission and Msg4 reception in Type-1 CSS. A WTRU may monitor a random access response (RAR), a DCI to schedule an uplink transmission for Msg3 (RRC connection request) and a DCI scheduling a PDSCH including Msg4 (e.g. contention resolution) in the configured Type1-CSS. NCE RAR transmission may be indicated in a DCI received in a PDCCH transmission within a RAR window.

In an example, as shown in FIGS. 3A-3B, a WTRU in CE cell access mode may monitor RAR in a set of repeated Type-1 CSS in different CORESETs within a longer RAR window. A WTRU may be (pre)configured with a set of common search space with identical configurations. In one example, the repeated search space may be associated with a group of search space identities, e.g., search space ID indicated in the SIB1 information.

According to certain embodiments, a WTRU may perform at least the following operations in NCE or CE cell access mode. The CE and NCE operations in CONNECTED state may be determined based on one or more of the following component(s) and/or properties: scheduling timeline, BWP adaptation, CSI measurement and reporting, UL control information (UCI) and SRS transmission, and/or power control.

For example, a WTRU may be (pre)configured with one or more minimum scheduling timeline including a minimum time gap between e.g., PDCCH scheduling PDSCH and HARQ transmission corresponding to the scheduled PDSCH, PDCCH scheduling PDSCH and the start of the scheduled PDSCH and PDCCH scheduling PUSCH and start of the scheduled PUSCH.

Minimum scheduling is to ensure a WTRU may have adequate time to perform all the processing required for the operation, e.g., to decode the scheduling information in a PDCCH, to decode the scheduled PDSCH, and/or to transmit the scheduled PUSCH. NCE scheduling timeline may be based on a number of symbols and CE scheduling time may be (pre)configured based on a number of sub-slots, slots, sub-frames and/or radio frames.

CE BWP may be (pre)configured at different center frequency location within a carrier and with identical bandwidth. A WTRU may transmit and/or receive signals and/or channels within the same bandwidth. A WTRU may perform re-tuning to operate in a different CE BWP as indicated by the network and/or according to a (pre)configuration of, e.g., CORESET repetition, PRACH repetition and frequency hopping, etc. A WTRU in CE mode may apply a transition delay, e.g., of a number of sub-slots, slots, sub-frames, and/or radio frames to switch CE BWP with re-tuning.

NCE BWP may be (pre)configured at different center frequency location and variable bandwidth within a carrier. A WTRU may adapt and/or switch a NCE BWP based on network indication and/or expiration of a (pre)configured timers. A WTRU in NCE mode may apply a transition delay, e.g., of a number of symbols to perform a NCE BWP adaption and/or switch.

With respect to CSI measurement and reporting, in some embodiments, a WTRU may be (pre)configured to measure, determine and/or report CSI including, e.g., channel quality index (CQI), rank indicator (RI), layer indicator (LI), precoding matrix index (PMI), L1-RSRP, L1-SINR, CSI-RS resource indicator (CRI), and/or SSB resource indicator (SSBRI).

CE CSI measurement may be based on one or more common RS transmissions (pre)configured within each sub-slot/slot/sub-frame for measurement. A CE common RS may occupy the same bandwidth as the CE SSB, CE PDCCH, and/or CE PDSCH transmitted within the same sub-slot/slot/sub-frame. CE common DL RS may be transmitted with reduced number of antenna ports, e.g. one or two. CE CSI measurement and reporting may be based on Type 1 CSI reporting (e.g., SU-MIMO with maximum of two layers).

NCE CSI measurement may be based on a set of CSI-RS configurations including CSI-RS time and frequency resources. NCE CSI measurement and reporting may be based Type 1, Type 2 and Type 3 CSI reporting (e.g. to support SU/MU-MIMO with maximum of 64 layers).

CE UCI may apply a smaller payload, e.g., CSI with up to 2 layer and a (pre)configured repetition. CE SRS transmission may have the same bandwidth as the CE PUSCH transmission. NCE PUCCH and/or SRS configurations may be based on dedicated configuration including allocated time and frequency resources.

CE power control may be based on a maximum power less than the NCE maximum power. In another example, CE power control may apply a larger power adjustment step size, e.g., the power level adjustment in response to power control command received from the network. Also, CE power control may base on fewer transmit power levels and/or transmit power range than NCE power control. In one example, the CE power control may be based on (pre)configured low, medium and high range levels. In another example, the CE transmit power may be fixed at a (pre)configured level.

Certain embodiments may include initial access in CE mode and/or NCE mode. In an embodiment, there may be conditions associated with performing initial access in CE and/or NCE mode. For example, a WTRU may be (pre)configured, (pre)defined, indicated and/or determine to acquire an initial cell access in a cell access mode, e.g., CE and/or NCE mode based on one or more of the following: default mode associated with a WTRU type, frequency range (e.g., FR1, FR2 or FR3), frequency band, carrier type, measurement of initial access signals and/or channels, network indication in a NCE SSB, network indication in a CE SSB to perform initial access in NCE mode, WTRU device status, and/or WTRU application and service type.

According to some embodiments, there may be a default mode associated with a WTRU type. In one example, a default cell access mode of CE mode may be associated with WTRU type with reduced capability. The reduced capability may include narrow RF bandwidth of the WTRU TRX (e.g. 200 kHz, 1 MHz, 3 MHz), small battery capacity (e.g. in a sensor, wearable, meter), limited number of TX and/or RX antennas (e.g. 1 TX and 1 RX antenna), limited CPU processing and memory size (e.g. slow internal clock and 1 or 2 HARQ soft buffers), etc.

In another example, a primary cell access mode (NCE mode) and a secondary cell access mode (CE mode) may be associated with WTRU type with advanced capability. The advanced capability may include a large RF bandwidth of the WTRU TRX (e.g. 100 MHz, 200 MHz), high battery capacity (e.g. in a smart phone, consumer premise equipment), large number of TX and/or RX antennas (e.g. 4 TX and 8 RX antenna), high CPU processing and memory size (e.g. fast internal clock and 8 or 16 HARQ soft buffers), etc.

In one embodiment, a WTRU associated with both primary (NCE) and secondary (CE) cell access may determine to perform initial access in primary/NCE mode before and/or during initial access and may determine to switch, i.e., perform initial access in secondary/CE mode based on one or more conditions discussed in this section.

In an embodiment, a WTRU may be configured with a sequence comprising different CE modes that the WTRU will apply according to the configured sequence to perform initial access.

In one example, different frequency ranges (e.g., FR1, FR2 or FR3) may be associated to different cell access modes. In one example, different frequency bands may be associated to different cell access modes.

According to some embodiments, a carrier may be (pre)configured for a specific cell access mode. In one example, a WTRU associated with both NCE and CE cell access mode may determine to perform initial access in a cell access mode according to the (pre)configuration of a carrier. In another example, a carrier may include a group of GSCNs (pre)configured for NCE cell access mode and another group of GSCNs for CE cell access mode. A WTRU associated with both NCE and CE cell access mode may determine to perform initial access in a cell access mode according to (pre)configured GSCN group.

In certain embodiments, a WTRU associated with both NCE and CE cell access mode may determine to perform initial cell access in CE mode when the WTRU may not detect one signal (e.g., an initial access signal) and/or channel associated with a NCE SSB. In one example, a WTRU may determine to perform initial cell access in CE mode when the UE may not detect NCE PSS/SSS transmissions at one or more GSCNs within a carrier. In another example, a WTRU may determine to perform initial cell access in CE mode when the measurement (e.g. RSRP/RSSI) of the detected NCE PSS, SSS and/or PBCH DMRS may be below a threshold.

In one example, a WTRU may be indicated with a NES state, e.g., in a detected SSB. The NES state may indicate the gNB/NW in an energy saving state, low activity state, dormant state, etc. A WTRU associated with both NCE and CE cell access mode may determine to perform initial access in CE mode when NES state may be indicated. The WTRU may determine to perform initial access in NCE mode when NES state may not be indicated. The indication may be based on an (pre)configured index of PSS, SSS and/or PBCH DMRS sequences received in an SSB.

In another example, a WTRU may be indicated with a cell access mode to apply, e.g., in a received PBCH. A WTRU associated with both NCE and CE cell access mode may determine to perform initial access in CE mode when CE cell access mode may be indicated in a received NCE PBCH. The WTRU may continue with initial access in NCE mode when NES state may not be indicated.

In another example, a WTRU may receive an indication associated with SSB adaptations, including any of adaptation of SSB burst periodicity, change in number of active SSBs in a burst, change in SSB Tx power, etc. Such indication on SSB adaptation may correspond to adaptation to any of, including a subset of SSBs associated with NCE SSB and CE SSB configurations. A WTRU may be (pre)configured with one or more threshold values associated with any of the SSB adaptations. When receiving such an indication, the WTRU may apply the associated threshold values when determining to perform initial access in NCE mode or CE mode. In an example, upon receiving an indication on SSB adaptation, the initial access performed in CE mode according to the associated threshold values may result in a failure. In this case, the WTRU may transmit an indication (e.g. using associated RACH or UL-WUS resource) informing on the failure when subsequently performing initial access in NCE mode.

In one example, a WTRU may determine one or more of the parameters associated to CE SSB transmission based upon the received NCE SSB. The WTRU may be configured to determine one or more of the parameters associated to CE SSB transmission if the WTRU detected NCE SSB passes a quality criterion, e.g., RSRP of the received SSB being larger than a configured threshold. The WTRU determination may be based upon implicit or explicit indication received with the detected SSB. In one example of implicit indication, the PSS/SSS sequences may have a mapping with one of the physical parameters of the CE SSB, e.g., a given PSS sequence may indicate a specific periodicity, or a specific frequency offset for the CE SSB. In one example of explicit indication, a bit in MIB, PBCH PHY payload or PBCH DMRS scrambling initialization may indicate one of the physical properties to detect CE SSB.

According to some embodiments, a WTRU may be indicated with a given cell access mode to apply based upon network indication through signals associated to one of the cell access modes. The WTRU may be configured to determine one or more of the parameters associated to NCE SSB transmission if the WTRU detected CE SSB passes a quality criterion, e.g., RSRP of the received SSB being larger than a configured threshold. The WTRU associated with both NCE and CE cell access mode may determine to perform initial access in NCE mode based upon received signals (e.g., SSB) associated with one of the CE modes. This may for example be the case when the network is transmitting SSB associated with CE mode more often than the SSB associated with NCE mode. In another example, the network may be transmitting an SSB with a very small time-frequency footprint more often compared to the SSB associated to NCE cell mode. In that case, the small time-frequency footprint SSB can be used by the network to indicate users about the NCE SSB.

In one example, a WTRU may determine one or more of the parameters associated to NCE SSB transmission based upon the received CE SSB. The WTRU determination may be based upon implicit or explicit indication received with the detected SSB.

According to certain embodiments, initial access may be based on the WTRU device status. In one example, a WTRU associated with both NCE and CE cell access mode may determine to perform initial access in CE mode when WTRU power saving state (e.g. DRX) may be active, WTRU battery level may be lower than a threshold and/or WTRU device temperature may be higher than a threshold.

In another example, a WTRU associated with both NCE and CE cell access mode may determine to perform initial access in CE mode when WTRU mobility level, e.g., velocity may be higher than a threshold.

In a further example, a WTRU may determine to apply a cell access mode (pre)configured for the UE's geographic location determined based on GNSS information.

According to certain embodiments, initial access may be based on the WTRU application and/or service type. In one example, a WTRU associated with both NCE and CE cell access mode may determine to perform initial access in CE mode when the throughput and latency associated with the WTRU application and service type may be below or above a threshold, e.g., below a throughput threshold and/or above a latency threshold.

In one example, a WTRU performing initial access for a high priority and/or low latency service may use the CE mode leading to lower latency. This may for example be the case when CE and NCE modes are associated with different periodicities for system information transmission.

According to certain embodiments, initial access may be performed in CE mode. The WTRU may then receive CE MIB and SIB1. For example, a WTRU associated with both NCE and CE mode may determine to perform initial access in CE mode within a carrier (as indicated in the right part of FIG. 3) according to one or more conditions discussed above. In one example, a WTRU may detect a CE PSS/SSS at (pre)configured frequency locations (e.g., GSCN) associated with CE mode within a carrier. The PSS/SSS bandwidth may be (pre)defined for the CE mode.

A WTRU may perform a detection of a single (pre)configured CE PSS to determine whether the CE SSB may be present at the GSCN. When the CE PSS may be detected, a WTRU may receive a CE SSS at the same GSCN and acquire a PCID, e.g. based on the index of the received SSS sequence. When a WTRU may not detect a CE PSS/SSS at the (pre)configured GSCNs, a WTRU may determine to perform initial access in NCE mode in another (pre)configured carrier.

A WTRU may receive a CE PBCH in a (pre)configured repetition pattern. The CE PBCH may include information common for CE and NCE cell access mode, e.g., SFN, cell access permission, intra-frequency cell selection information, etc. A WTRU may determine whether the cell may be accessed based on cell access permission information received in the CE PBCH.

The CE PBCH may include information specific for CE cell access mode, e.g., an indication for CORESET 0 and/or Type-0 CSS repetition. In one example, a set of repetition pattern may be (pre)configured and the index of the applied pattern may be indicated. A frequency hopping may be used for CORESET 0 repetition, i.e. each CORESET 0 may be transmitted in different frequency location according to a frequency hopping pattern. A WTRU may retune the receive bandwidth to receive PDCCH in repeated CORESET 0 at different center frequency location. A WTRU may determine the center frequency of each repeated CORESET 0 based on the center frequency of the SSB and the relative offset included in the (pre)configured pattern.

The CORESET 0 and/or Type-0 CSS repetition pattern may indicate number of slots, sub-frames and radio frames of each pattern and the periodicity of the pattern. A WTRU may apply a (pre)configured and fixed PDCCH configuration to decode the PDCCH scheduling CE SIB1 transmission. The PDCCH configuration may include e.g., fixed aggregation level, single DCI format.

A WTRU may receive CE SIB1 information (with the content as described in section 4.1) carried in one or more PDSCHs scheduled by the PDCCH decoded in the repeated CORESET 0/Type-0 CSS.

According to some embodiments, a WTRU may transmit RACH to access the cell in CE mode. For example, a WTRU may transmit a CE PRACH (i.e. preamble) according to the received SIB1 configuration. In one example, a WTRU may transmit a preamble for each repeated CORESET 0, i.e., a preamble transmission associated with each repeated CORESET 0. After preamble transmission, a WTRU may monitor a repeated RAR in each of the configured Type-1 CSS and the Type-1 CSS repetition patter may be indicated in SIB1 information. A WTRU may perform Msg3 transmission and Msg4 reception according to the scheduling information received in the PDCCHs in Type-1 CSS.

In one example, a UE may transmit an indication to the network indicating its preferred or requested cell access mode. The preferred cell access mode may be NCE mode and/or one of the CE modes.

In another example, a WTRU may transmit a CE PRACH (i.e. preamble) according to the received CE SIB1 configuration to indicate the WTRU may be associated with both NCE and CE mode. Alternatively, the WTRU may transmit the CE PRACH in an associated RACH occasion in time and/or frequency domain or include a scrambling code in a subset of the CE PRACH resources for indicating that the WTRU may be associated with both NCE or CE modes.

In another example, a WTRU may transmit a CE PRACH and/or UL Wake-Up signal (WUS) to request NCE SSB transmission according to the information indicated in the CE SIB1 information. For example, the NCE SSB transmission may be turned off, transmitted at a lower power and/or transmitted at a very larger periodicity (e.g. once every 160 ms) for network energy saving purpose. The network may activate and/or switch the network energy saving state and indicate to the WTRU to perform another initial access based on the NCE SSB.

In a further example, a WTRU may transmit a CE PRACH to request NCE MIB and/or SIB1 information. A WTRU may determine CE RACH occasion associated with CORESET 0 repetition pattern indicated in CE MIB. A WTRU may perform frequency hopping to transmit repeated pre-ambles in RACH frequency allocation associated with each CORESET 0. Alternatively, a WTRU may transmit a NCE MIB and/or SIB1 request in a MAC CE in a PUSCH.

According to an embodiment, a WTRU may determine a preferred cell access mode. The preferred cell access mode may be NCE mode and/or one of the CE modes. The UE determination of the preferred cell access mode may be based upon any one or more of the following: frequency range, frequency band, carrier frequency, carrier type; WTRU device type/category; WTRU device status (e.g., battery status, UE temperature, UE location, etc.); the cell access mode currently used by the network or as detected by the WTRU; signal measurements made by the WTRU; and/or WTRU application and service type that WTRU intends to use.

In one example, the network may configure the WTRU to provide an indication of preferred cell access modes from a given set of access modes, e.g., as broadcast by system information. In another example, the WTRU may be configured to provide an indication of preferred cell access mode from the cell access modes based upon the WTRU capability.

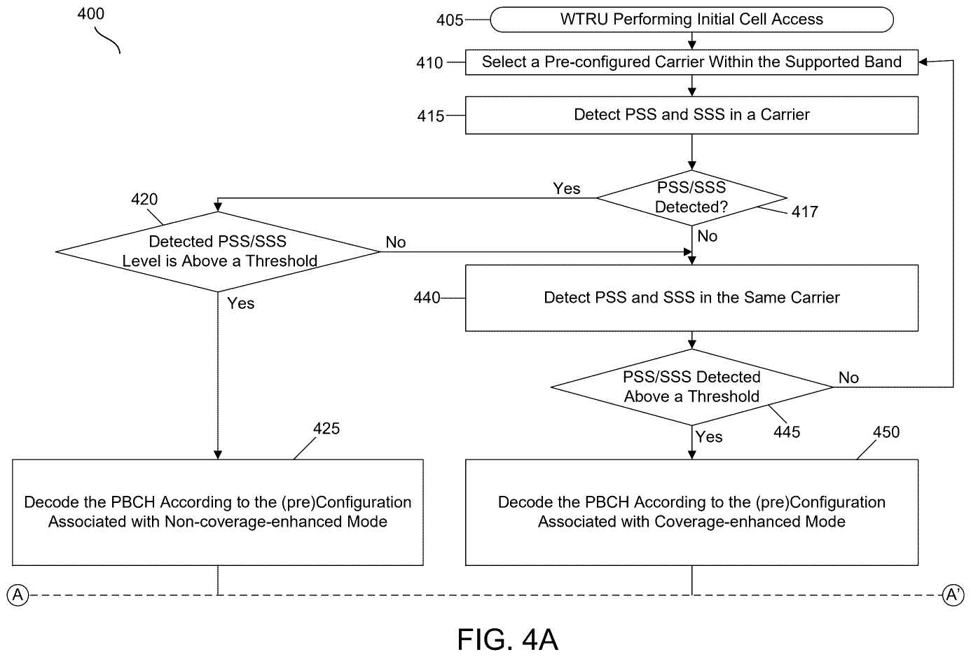

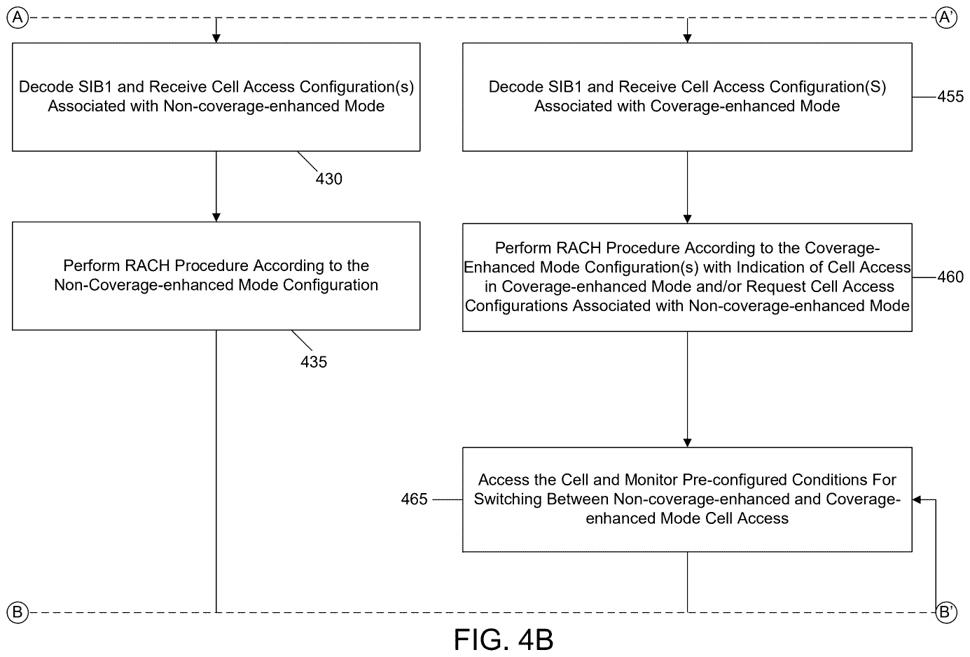

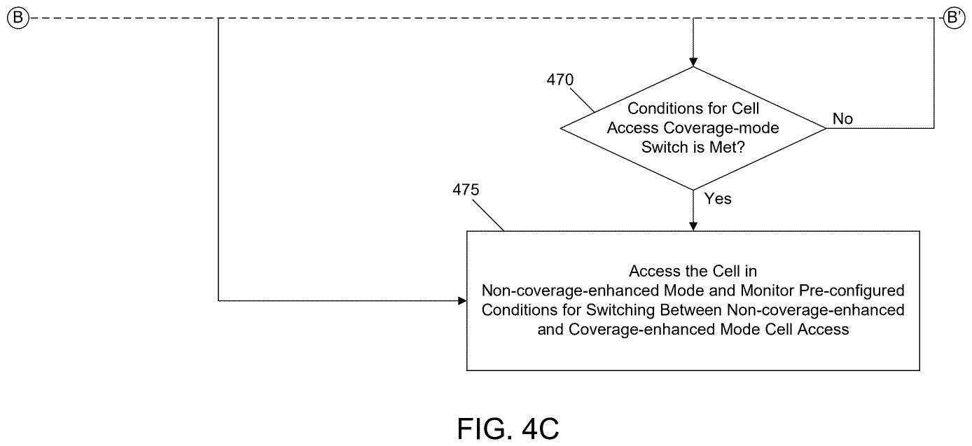

According to some embodiments, a UE associated with both NCE and CE mode may determine to perform an initial access in NCE mode (e.g., as shown in the example of FIGS. 4A-4C, e.g., in blocks 425, 430, 435, 475, as discussed below) according to one or more conditions discussed above. In one example, a WTRU may detect a NCE PSS/SSS at (pre)configured frequency locations (e.g., GSCN) associated with CE mode within a carrier and the measured NCE PSS/SSS RSRP, RSSI, RSRQ level may above a threshold.

A WTRU may receive a NCE PBCH according to NCE PBCH (pre)configuration. The NCE PBCH may include also common MIB information and NCE-mode specific information. The common information may include SFN, cell access permission information and inter-frequency cell re-selection information. The NCE-mode specific information may include, e.g., SCS used for NCE mode and an indication of a single CORESET 0 and/or Type-0 CSS for PDCCH monitoring. A WTRU may receive NCE SIB1 information (with the content e.g., as described in section 4.1) carried in one or more PDSCHs scheduled by the PDCCH decoded in the repeated CORESET 0/Type-0 CSS.

In certain embodiments, a WTRU may transmit RACH to access the cell in NCE mode. For example, a WTRU may transmit a NCE PRACH (i.e. preamble) according to the received SIB1 configuration. In one example, a WTRU may transmit a preamble associated with a SSB and a RAR window. A WTRU may receive a RAR in a Type-1 CSS (configured in NCE SIB1) and perform Msg3 transmission and Msg4 reception according to the scheduling information received in the PDCCHs in Type-1 CSS.

According to some embodiments, a WTRU may receive NCE MIB and/or SIB information. For example, a WTRU may receive MIB and/or SIB (e.g., SIB1) information in a NCE PDSCH pertaining to NCE cell access mode following transmission to indicate NCE mode cell access. The CE MIB information may include the MIB information specific to NCE cell access mode, e.g., the bandwidth within the carrier (BWP information), SCS used for NCE data operation, NCE CORESET and search space configuration, PDSCH and PUSCH configuration (maximum TBS size and schedule timeline), CSI-RS configuration, etc.

In an embodiment, a WTRU may be indicated in CE SIB1 and/or RRC configurations the configuration for NCE SSB transmission. The indicated NCE SSB configuration may include the time and frequency resource, periodicity and QCL information (e.g. QCL:ed with the CE common DL RS transmission). A WTRU may receive the NCE SSB transmission according to the configuration when the detected NCE SSB level may, e.g., be above a threshold. A WTRU may receive NCE MIB information regarding NCE CORESET 0 and Type-0 CSS and NCE SIB1 information.

According to certain embodiments, a WTRU may monitor and/or measure the NCE SSB and/or CSI-RS according to the received NCE configurations and perform NCE-to-CE switch as will be discussed in more detail below.

In an embodiment, a WTRU may transmit an indication to the network indicating its preferred cell access mode. The preferred cell access mode may be NCE mode and/or one of the CE modes.

In another example, a WTRU may transmit a NCE PRACH (i.e. preamble) according to the received CE SIB1 configuration to indicate the WTRU may be associated with both NCE and CE mode. Alternatively, the WTRU may transmit the NCE PRACH in an associated RACH occasion in time and/or frequency domain or include a scrambling code in a subset of the CE PRACH resources for indicating that the WTRU may be associated with both NCE or CE modes.

In another example, a WTRU may transmit a NCE PRACH and/or UL Wake-Up signal (WUS) to request NCE SSB transmission according to the information indicated in the CE SIB1 information. For example, a WTRU may not detect and receive CE SSB and SIB1 information, which may not be the default initial cell access mode for the WTRU. The network may provide the CE SSB and/or SIB1 configuration and indicate the WTRU to perform another initial access based on the CE SSB.

In a further example, a WTRU may transmit a NCE PRACH to request CE MIB and/or SIB1 information. A WTRU may determine NCE RACH occasion associated with CORESET 0 repetition pattern indicated in NCE MIB. A WTRU may perform frequency hopping to transmit repeated pre-ambles in RACH frequency allocation associated with each CORESET 0. Alternatively, a WTRU may transmit a NCE MIB and/or SIB1 request in a MAC CE in a PUSCH.

A WTRU may receive CE MIB, SIB1 and other cell access configuration information and a WTRU may switch to using these configuration when a WTRU may perform a switch from NCE mode to CE mode, as described in more detail below.

FIGS. 4A-4C illustrate an example flow diagram of a method 400 relating to initial cell access and/or for switching between cell access modes, according to some example embodiments. The example method 400 of FIGS. 4A-4C and accompanying disclosures herein may include, may be based on, or may be a synthesization of various embodiments or elements discussed in detail above, such as those discussed with respect to FIGS. 2-3. For convenience and simplicity of exposition, the example of FIGS. 4A-4C may be described with reference to the architecture or system described above with respect to FIGS. 1A-1D, for instance. However, the example method 400 depicted in FIGS. 4A-4C may be carried out using different architectures as well. According to some embodiments, the method 400 of FIGS. 4A-4C may be implemented by WTRU (e.g., WTRU 102), UE, mobile device, or the like.

It is noted that the method 400 of FIGS. 4A-4C may include further steps, procedures or details as discussed in detail elsewhere in this disclosure. As such, the method 400 of FIGS. 4A-4C may be modified to include any of the steps, procedures, elements and/or details illustrated and/or discussed in the foregoing. Moreover, it is noted that the method and/or blocks of FIGS. 4A-4C may be modified to include, or to be replaced by, any one or more of the procedures, elements or blocks discussed elsewhere herein. As such, one of ordinary skill in the art would understand that FIGS. 4A-4C is provided as one example and modifications thereto are possible while remaining within the scope of certain example embodiments as described herein.

As illustrated in the example of FIG. 4A, at 405, the WTRU may begin performing initial cell access. At 410, the method 400 may include selecting a pre-configured carrier within a supported band. The method 400 may include, at 415, detecting PSS and/or SSS in a carrier, for example, according to pre-configuration of synchronization frequency channel and/or raster associated with non-coverage-enhanced mode.

In certain embodiments, the method 400 may include, at 417, determining whether PSS/SSS is detected. If PSS/SSS is detected, the method 400 may include, at 420, determining whether the detected PSS/SSS level is above a threshold. If it is determined that the detected PSS/SSS level is above a threshold, the method 400 may include, at 425, decoding the PBCH according to the configuration associated with NCE mode. As illustrated in FIG. 4B, the method 400 may then include, at 430, decoding SIB (e.g., SIB1) and receiving cell access configuration(s) associated with NCE mode. The cell access configuration(s) associated with NCE Mode may be received with no or less repetition for CORESET/USS and/or RACH/PUCCH, more DCI formats with larger payload, shorter schedule delaying and HARQ timeline, increased maximum TX power, TB size, MCS table, layer of transmission, RLM measurement, etc. In an embodiment, the method 400 may then include, at 435, performing RACH procedure according the NCE mode configuration. According to certain embodiments, this may also include indicating cell access in the NCE mode (e.g., that the WTRU is camping on cell in NCE mode) and requesting cell access configuration(s) associated with CE mode. The method 400 may then include, at 475, accessing the cell in NCE mode (and possibly performing date operation), and monitoring for configured conditions associated with switching between NCE and CE mode cell access. These conditions are discussed in more detail elsewhere herein and may include, for example, SSB/RS measurement(s), WTRU power saving state, network indication, etc.

If PSS/SSS is not detected at 417 or if it is determined that the detected PSS/SSS level is not above a threshold at 420, the method 400 may include, at 440, detecting PSS and/or SSS in the same carrier. For example, PSS and/or SSS may be detected according to pre-configuration of synchronization frequency channel and/or raster associated with CE mode. At 445, it may be determined whether the detected PSS/SSS is above a threshold. If it is determined that the detected PSS/SSS is not above the threshold, then the method 400 may return to block 410. If it is determined that the detected PSS/SSS is above the threshold, then the method 400 may include, at 450, decoding the PBCH according to the (pre)configuration associated with CE mode and possibly including specific information. For example, direct SIB1 acquisition, CORESET/CSS 0 repetition indication (Based on SS Level), etc. As illustrated in FIG. 4B, the method 400 may then include, at 455, decoding SIB (e.g., SIB1) and receiving cell access configuration(s) associated with CE mode. For example, the cell access configuration(s) associated with CE mode may include any one or more of the following: WTRU-specific CORESET/SS with repetition, smaller DCI payload, fewer DCI formats for decoding, pre-amble format with smaller SCS, RACH repetition and frequency hopping pattern, RAR configuration with large window and repetition, PUCCH repetition parameters, extended scheduling delay and HARQ timeline, limited maximum TX power, limited maximum TB size, limited MCS table, limited layers of transmission, reduced RLM measurement, etc.

As illustrated in the example of FIG. 4B, the method 400 may include, at 460, performing RACH procedure according the CE mode configuration(s). This may include indicating cell access in CE mode (e.g., indicating that WTRU is camping on cell in CE mode) and/or requesting cell access configuration(s) associated with NCE mode. For example, the WTRU may request cell access configuration(s) associated with NCE mode that are similar as those associated with CE mode with no/less repetition for CORESET/USS and/or RACH/PUCCH, more DCI formats with larger payload, shorter schedule delaying and HARQ timeline, increased maximum TX power, TB size, MCS table, layer of transmission, RLM measurement(s), etc. At 465, the method 400 may include accessing the cell in CE mode (and possibly performing date operation), and monitoring for (pre)configured conditions associated with switching between NCE and CE mode cell access. These conditions are discussed in more detail elsewhere herein and may include, for example, SSB/RS measurement(s), WTRU power saving state, network indication, etc.

As illustrated in FIG. 4C, the method 400 may include, at 470, determining whether one or more conditions associated with cell access coverage mode switching is met. If it is determined, at 470, that the condition(s) are not met, then the method 400 may return to block 465. If it is determined, at 470, that the condition(s) are met, then the method 400 may include, at 475, accessing the cell in NCE mode (and possibly performing date operation), and monitoring for configured conditions associated with switching between NCE and CE mode cell access. These conditions are discussed in more detail elsewhere herein and may include, for example, SSB/RS measurement(s), WTRU power saving state, network indication, etc.

In some embodiments, a WTRU may be (pre)configured with one or more event(s) and/or condition(s) associated with a cell access mode switch, e.g., from NCE to CE mode and/or from CE to NCE mode. When a WTRU may determine one or more (pre)configured event(s) and/or condition(s) may occur, the WTRU may perform one or more of the following: reporting in an UL transmission including the occurred event(s) and/or conditions and/or a request for cell access mode switch; and/or determining to perform a cell access mode switch corresponding to the occurred event(s) and/or conditions and performs a UL transmission to indicate the switch.

A WTRU may be (pre)configured with one or more of the following event(s) and/or condition(s) associated with cell access mode switch: Measured and/or monitored channel condition, Network energy saving (NES) state of the cell, WTRU power saving state, WTRU processing load, WTRU data traffic, WTRU geographic location, and/or WTRU battery status and/or consumption.

In one example, a WTRU may switch from NCE mode to CE mode when the measured and/or evaluated RSSI, RSRP, RSRQ and/or L1-SINR SSB and/or CSI-RS transmissions according to the NCE mode cell access configuration may be below a threshold. In another example, a WTRU may switch from CE mode to NCE mode when the measured and/or evaluated RSSI, RSRP, RSRQ and/or L1-SINR SSB and/or CSI-RS transmissions according to the NCE mode cell access configuration may be above a threshold.

In one example, a WTRU may be (pre)configured with different thresholds associated with NCE-to-CE cell access mode switch and CE-to-NCE cell access mode switch. In another example, a threshold may be associated with reported WTRU capability. In a further example, a threshold may be associated with Block Error Ratio (BLER) of a downlink control and/or data reference channel transmission. A control reference channel may, e.g., carry a DCI format 1_0 with a fixed Aggregation Level (AL) of 16.

In another example, a WTRU may switch from NCE mode to CE mode when a WTRU detects a beam failure and/or radio link failure. Alternatively, a WTRU may be (pre)configured with an additional monitoring threshold for beam and radio link monitoring, which may be reached before the threshold for beam failure and/or radio link failure may be reached. A WTRU may perform a cell access mode switch before the beam failure and radio link failure are detected.

According to an embodiment, a WTRU may determine a NES state of a cell. For example, the NES state of the cell may be detected, e.g., based on cell DTX/DRX, reduced SSB transmissions, adapted spatial and power domain transmission configuration, and/or reduced BWP operation. In one example, a WTRU may switch from NCE mode to CE mode when the WTRU determines the cell may enter a NES state. In another example, a WTRU may switch from CE mode to NCE mode when the WTRU determines the cell may exit a NES state.

In an embodiment, a WTRU may determine to apply a cell access mode corresponding to a UE power saving state, e.g., based on DRX operation. In one example, a WTRU may switch from NCE mode to CE mode when the WTRU enters (or will enter) a power saving state and/or perform DRX operation. In another example, a WTRU may switch from CE mode to NCE mode when the UE exits (or will be exiting) the UE power saving state.

According to an embodiment, a WTRU may determine a processing load based on CPU processing load and/or memory consumption for one or more performed operation(s), e.g. PDCCH blind detection, CSI computation, HARQ re-transmissions, etc. In one example, a WTRU may switch from NCE mode to CE mode when the WTRU determines the processing load may be above a threshold. In another example, a WTRU may switch from CE mode to NCE mode when the WTRU determines the processing load may be below a threshold.

In an embodiment, a WTRU may determine data traffic based on the size of the data in the WTRU buffer. In one example, a WTRU may switch from NCE mode to CE mode when the WTRU determines the WTRU data traffic may be below a threshold. In another example, a WTRU may switch from CE mode to NCE mode when the WTRU determines the WTRU data traffic may be above a threshold.

According to an embodiment, a WTRU may determine its geographic location. For example, the WTRU may determine the geographical location of the WTRU and/or the camped cell based on zone ID and/or GNSS information. In one example, a WTRU may determine to apply a cell access mode (pre)configured for the UE's and/or camped cell's geographic location.

In one example, a WTRU may switch from NCE mode to CE mode when the UE determines the battery status may be below a threshold and/or the battery consumption may be above a threshold. In another example, a WTRU may switch from CE mode to NCE mode when the UE determines the battery status may be above a threshold and/or the battery consumption may be below a threshold.

Certain embodiments may include a network indicated cell access mode switch. For example, when one or more above-discussed (pre)configured event(s) and/or condition(s) associated with a cell access mode switch may occur, a WTRU may report the occurred event(s) and/or condition(s) to the network, e.g., as assistance information, to trigger a NW-indicated cell access switch. A WTRU may transmit the reporting in RRC signaling in PUSCH, MAC CE in PUSCH and/or in UCI in PUCCH.

In an embodiment, when one or more above-discussed (pre)configured event(s) and/or condition(s) associated with a cell access mode switch may occur, a WTRU may transmit a cell access mode switch request in an UL transmission to the network.

According to an embodiment, a WTRU may transmit a cell access mode switch request in a random access channel transmission, e.g., PRACH. A WTRU may be (pre)configured with one or more Contention Free Random Access (CFRA) PRACH preambles for a CE-to-NCE and/or NCE-to-CE switch request. In another example, a (pre)configured preamble may correspond to a cell access mode, e.g., CE mode or NCE mode.

In another example, a WTRU may transmit a cell access mode switch request in a UL control channel transmission, e.g., PUCCH. A WTRU may indicate the CE-to-NCE or NCE-to-CE switch request in a codepoint in the PUCCH transmission.

In an embodiment, a WTRU may be indicated by the network to apply and/or switch a cell access mode, e.g., between NCE and CE mode. A WTRU may switch between cell access in NCE and CE mode based on this indication. A WTRU may receive the cell access mode switch indication in RRC signaling and/or a MAC CE.

According to some embodiments, a WTRU may receive the cell access mode switch indication in a DCI format received in a PDCCH and/or a group common PDCCH. The cell access mode switch indication (e.g., in a DCI format and/or a MAC CE) may base on a codepoint to indicate an identity of the cell access mode to apply. In one example, when two cell access modes, e.g., NCE and CE mode may be indicated, a WTRU may (pre)configured with one-bit information field for cell access mode indication in the DCI format and/or MAC CE. In another example, the mode switch indication may apply a codepoint of 0 to indicate no switching of cell access mode and codepoint of 1 to indicate a switching of cell access mode, from NCE to CE mode or from CE mode to NCE mode. The network may indicate, to the WTRU, not to switch e.g., due to the traffic load in the cell for CE mode and NCE mode UEs.

Certain embodiments may include WTRU-initiated cell access mode switch. According to some embodiments, a WTRU may determine to apply a different cell access mode, i.e., perform a cell access mode switch when one or more associated event(s) and/or conditions(s) associated with cell access mode switch, as discussed elsewhere herein, may occur (e.g., based on event(s) and/or condition(s) triggering the cell access mode switch).

In an embodiment, when a WTRU performs a cell access mode switch based on NW indication and/or WTRU initiation, the WTRU may send a cell access mode switch indication in an UL transmission to the network. For example, the information content of the indication may be as follows: an acknowledgement of a cell access mode switch indicated by the network in RRC, MCA CE and/or DCI signaling; and/or an indication of the cell access mode after UE may determine to switch the cell access mode.

In one example, a WTRU may transmit a HARQ ACK corresponding to a cell access mode switch indicated in a DCI format received in a PDCCH.

In another example, a WTRU may transmit a cell access switch indication in a Contention Free Random Access (CFRA) PRACH preambles. A WTRU may be (pre)configured with CFRA preamble corresponding to CE and NCE cell access mode and transmit a preamble corresponding to the cell access mode the UE may have switched to.

In a further example, a WTRU may indicate a cell access mode that the WTRU may have switched to in a UL control channel transmission, e.g., PUCCH. A WTRU may indicate the cell access mode, e.g. (CE or NCE mode) using a codepoint in the PUCCH transmission.

According to some embodiments, a WTRU may be (pre)configured with a cell access mode switch delay, e.g., a number of symbols, sub-slots and/or slots. A WTRU may finish the cell access mode switch and/or apply the configurations associated with the switched-to cell access mode within a (pre)configured switch delay. The switch delay may be relative to the reception of the network indication of switch or to the transmission of an indication for WTRU-initiated switch.

For example, a WTRU may start monitoring PDCCH according to the CORESET and CSS/USS configurations of the switched-to cell access mode. In another example, a WTRU may start CSI-RS measurement according to the CSI-RS measurement configurations of the switched-to cell access mode.

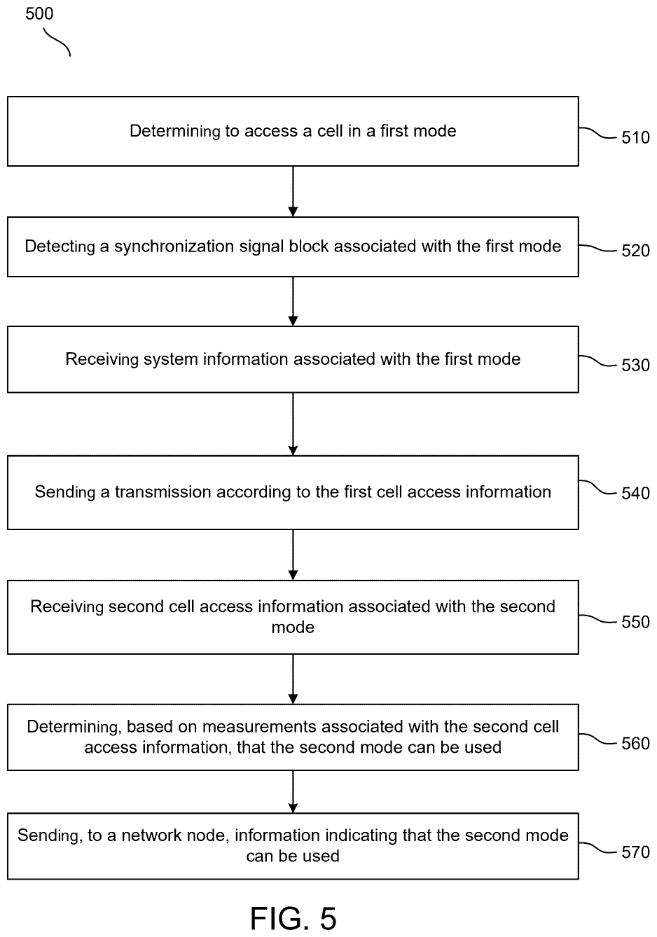

FIG. 5 illustrates an example flow diagram of a method 500 relating to initial cell access and/or for switching between cell access modes, according to some example embodiments. The example method 500 of FIG. 5 and accompanying disclosures herein may include, may be based on, or may be a synthesization of various embodiments or elements discussed in detail above, such as those discussed with respect to FIGS. 2-4. For convenience and simplicity of exposition, the example of FIG. 5 may be described with reference to the architecture or system described above with respect to FIGS. 1A-1D, for instance. However, the example method 500 depicted in FIG. 5 may be carried out using different architectures as well. According to some embodiments, the method 500 of FIG. 5 may be implemented by WTRU (e.g., WTRU 102), UE, mobile device, or the like.

It is noted that the method 500 of FIG. 5 may include further steps, procedures or details as discussed in detail elsewhere in this disclosure. As such, the method 500 of FIG. 5 may be modified to include any of the steps, procedures, elements and/or details illustrated and/or discussed in the foregoing. Moreover, it is noted that the method and/or blocks of FIG. 5 may be modified to include, or to be replaced by, any one or more of the procedures, elements or blocks discussed elsewhere herein. As such, one of ordinary skill in the art would understand that FIG. 5 is provided as one example and modifications thereto are possible while remaining within the scope of certain example embodiments as described herein.

As illustrated in the example of FIG. 5, the method 500 may include, at 510, determining to access a cell in a first mode, based on a synchronization signal block associated with a second mode. At 520, the method 500 may include detecting a synchronization signal block associated with the first mode.

In the example of FIG. 5, the method 500 may include, at 530, receiving system information associated with the first mode. The system information may indicate first cell access information associated with the first mode.

As illustrated in the example of FIG. 5, the method 500 may include, at 540, sending a transmission according to the first cell access information. The transmission may indicate that the WTRU is capable of both the first and second modes (e.g., is capable of operating in, applying, using, performing, etc. in both the first and second modes).

In the example of FIG. 5, the method 500 may include, at 550, receiving second cell access information associated with the second mode. At 560, the method 500 may include determining, based on measurements associated with the second cell access information, that the second mode can be used. At 570, the method 500 may include sending, to a network node, information indicating that the second mode can be used.

For example, in certain embodiments, the first mode may be a coverage-enhanced mode and the second mode may be a non-coverage-enhanced mode, or vice-versa.

In an embodiment, the determining 510 to access the cell in the first mode may include determining to access the cell in the first mode based on measurements of the synchronization signal block associated with the second mode being below a threshold or based on the synchronization signal block associated with the second mode not being detected.

According to an embodiment, the system information may be or may include a system information block 1 (SIB1).

In some embodiments, the sending 540 of a transmission according to the first cell access information may include sending any of a random access channel (RACH) transmission, a physical uplink shared channel (PUSCH) transmission, and/or a Msg3 transmission.

According to certain embodiments, the first cell access information may include any of random access channel (RACH) parameters for the first mode and/or Msg3 parameters for the first mode.

In some embodiments, the second cell access information may include any one or more of: a synchronization signal block associated with the second mode, a control resource set (CORESET), channel state information reference signal (CSI-RS) information, random access channel (RACH) configuration information, and/or a master information block (MIB).

According to certain embodiments, the measurements associated with the second cell access information may include measurements of a synchronization signal block and/or a reference signal associated with the second mode.

In an embodiment, the method 500 may further include sending a request to receive the second cell access information associated with the second mode.

According to some embodiments, the information indicating that the second mode can be used may include or may be a request to switch from the first mode to the second mode, and the method 500 may include receiving an indication, from the network node, to switch the access to the cell to the second mode.

Certain embodiments may be directed to a WTRU (e.g., WTRU 102 in FIGS. 1A-1D) that may be capable of operating (e.g., configured to operate) in two or more cell access modes (e.g., a non-coverage-enhanced mode and one or more coverage-enhanced modes). The WTRU may be configured to determine to access a cell in a first mode (e.g., a coverage-enhanced mode). For example, the WTRU may determine to access the cell in the first mode, based on a synchronization signal block associated with a second mode (e.g., based on measurements of a SSB associated with the second mode). The WTRU may be configured to receive system information associated with the first mode. The system information may indicate first cell access information associated with the first mode.

In an embodiment, the WTRU may be configured to send a transmission according to the first cell access information. The transmission may indicate that the WTRU is capable of both the first and second modes (e.g., is capable of operating in, applying, using, performing, etc. in both the first and second modes).

According to an embodiment, the WTRU may be configured to receive second cell access information associated with the second mode (e.g., a non-coverage-enhanced mode). The WTRU may be configured to determine, based on measurements associated with the second cell access information, that the second mode can be used. For example, the WTRU may be configured to perform measurements using the second cell access information and, based on those measurements, the WTRU may be configured to determine that the second mode can be used (e.g., is available or acceptable) by the WTRU. In an embodiment, the WTRU may be configured to send, to a network node, information indicating that the second mode can be used by the WTRU.

For example, in certain embodiments, the first mode may be a coverage-enhanced mode and the second mode may be a non-coverage-enhanced mode, or vice-versa.

In an embodiment, the WTRU may determine to access the cell in the first mode based on measurements of the synchronization signal block associated with the second mode being below a threshold or based on the synchronization signal block associated with the second mode not being detected.

According to an embodiment, the system information associated with the first mode may be or may include a system information block 1 (SIB1).

In some embodiments, the transmission that is sent according to the first cell access information may include any of a random access channel (RACH) transmission, a physical uplink shared channel (PUSCH) transmission, and/or a Msg3 transmission.

According to certain embodiments, the first cell access information may include any of random access channel (RACH) parameters for the first mode and/or Msg3 parameters for the first mode.

In some embodiments, the second cell access information may include any one or more of: a synchronization signal block associated with the second mode, a control resource set (CORESET), channel state information reference signal (CSI-RS) information, random access channel (RACH) configuration information, and/or a master information block (MIB).

According to certain embodiments, the measurements associated with the second cell access information may include measurements of a synchronization signal block and/or a reference signal associated with the second mode.

In an embodiment, the WTRU may be configured to send a request to receive the second cell access information associated with the second mode.

According to some embodiments, the information indicating that the second mode can be used may include or may be a request by the WTRU to switch from the first mode to the second mode. In an embodiment, the WTRU may be configured to receive an indication, from the network node, to switch the access to the cell to the second mode.

Example embodiments herein provide several technological improvements and/or benefits. For instance, as discussed in detail above, certain embodiments enable a WTRU of reduced capabilities to access a cell in a NCE mode and a WTRU capable of accessing a cell in either CE or NCE mode to select a path to acquire cell access (e.g., enter RRC CONNECTED) in a poor coverage scenario or in a power saving state. Some embodiments also provide a benefit of configuration signaling overhead reduction. For example, instead of the network transmitting individual re-configurations regarding e.g., CORESET, SS, PDSCH, PDCCH, CSI, etc., a cell access coverage mode re-configuration and/or switch can trigger the WTRU to apply previously received configurations corresponding to the switched-to cell access mode.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

In some example embodiments described herein, (e.g., configuration) information may be described as received by a WTRU from the network, for example, through system information or via any kind of protocol message. Although not explicitly mentioned throughout embodiments described herein, the same (e.g., configuration) information may be pre-configured in the WTRU (e.g., via any kind of pre-configuration methods such as e.g., via factory settings), such that this (e.g., configuration) information may be used by the WTRU without being received from the network.

Any characteristic, variant or embodiment described for a method is compatible with an apparatus device comprising means for processing the disclosed method, such as with a device comprising a processor configured to process the disclosed method, a computer program product comprising program code instructions and a non-transitory computer-readable storage medium storing program instructions.

The foregoing embodiments are discussed, for simplicity, with regard to the terminology and structure of infrared capable devices, i.e., infrared emitters and receivers. However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶ 6 or means-plus-function claim format, and any claim without the terms “means for” is not so intended.

Although various embodiments have been described in terms of communication systems, it is contemplated that the systems may be implemented in software on microprocessors/general purpose computers (not shown). In certain embodiments, one or more of the functions of the various components may be implemented in software that controls a general-purpose computer.

In addition, although some example embodiments are illustrated and described herein, the invention is not intended to just be limited to the details shown. Rather, various modifications and variations may be made in the details within the scope and range of equivalents of the claims and without departing from the spirit or scope invention.

1. A wireless transmit/receive unit (WTRU), comprising:
circuitry, including any of a processor and transceiver, configured to
determine to access a cell in a first mode, based on a synchronization signal block associated with a second mode;
detect a synchronization signal block associated with the first mode;
receive system information associated with the first mode, wherein the system information indicates first cell access information associated with the first mode;
send a transmission according to the first cell access information, wherein the transmission indicates that the WTRU is capable of both the first and second modes;
receive second cell access information associated with the second mode;
determine that the second mode can be used, based on measurements associated with the second cell access information; and
send, to a network node, information indicating that the second mode can be used.

2. The WTRU of claim 1, wherein the first mode comprises a coverage-enhanced mode and the second mode comprises a non-coverage-enhanced mode.

3. The WTRU of claim 1, wherein the WTRU is configured to determine to access the cell in the first mode, based on measurements of the synchronization signal block associated with the second mode being below a threshold or based on the synchronization signal block associated with the second mode not being detected.

4. The WTRU of claim 1, wherein the system information comprises any of a system information block 1 (SIB1) and master information block (MIB).

5. The WTRU of any of claims 1-4 claim 1, wherein the transmission comprises any of a random access channel (RACH) transmission and a Msg3 transmission.

6. The WTRU of claim 1, wherein the first cell access information comprises any of random access channel (RACH) parameters for the first mode and Msg3 parameters for the first mode.

7. The WTRU of claim 1, wherein the second cell access information comprises any of: a synchronization signal block associated with the second mode, a control resource set (CORESET), channel state information reference signal (CSI-RS) information, random access channel (RACH) configuration information, and a master information block (MIB).

8. The WTRU of claim 1, wherein the measurements associated with the second cell access information comprise measurements of a synchronization signal block or a reference signal associated with the second mode.

9. The WTRU of claim 1, configured to send a request to receive the second cell access information associated with the second mode.

10. The WTRU of claim 1, wherein the information indicating that the second mode can be used comprises a request to switch from the first mode to the second mode, and the WTRU is configured to receive an indication, from the network node, to switch the access to the cell to the second mode.

11. A method, implemented by a wireless transmit/receive unit (WTRU), the method comprising:
determining to access a cell in a first mode, based on a synchronization signal block associated with a second mode;
detecting a synchronization signal block associated with the first mode;
receiving system information associated with the first mode, wherein the system information indicates first cell access information associated with the first mode;
sending a transmission according to the first cell access information, wherein the transmission indicates that the WTRU is capable of both the first and second modes;
receiving second cell access information associated with the second mode;
determining that the second mode can be used, based on measurements associated with the second cell access information; and
sending, to a network node, information indicating that the second mode can be used.

12. The method of claim 11, wherein the first mode comprises a coverage-enhanced mode and the second mode comprises a non-coverage-enhanced mode.

13. The method of claim 11, wherein the determining to access the cell in the first mode comprises determining to access the cell in the first mode, based on measurements of the synchronization signal block associated with the second mode being below a threshold or based on the synchronization signal block associated with the second mode not being detected.

14. The method of claim 11, wherein the system information comprises any of a system information block 1 (SIB1) and master information block (MIB).

15. The method of claim 11, wherein the transmission comprises any of a random access channel (RACH) transmission and a Msg3 transmission.

16. The method of claim 11, wherein the first cell access information comprises any of random access channel (RACH) parameters for the first mode and Msg3 parameters for the first mode.

17. The method of claim 11, wherein the second cell access information comprises any of: a synchronization signal block associated with the second mode, a control resource set (CORESET), channel state information reference signal (CSI-RS) information, random access channel (RACH) configuration information, and a master information block (MIB).

18. The method of claim 11, wherein the measurements associated with the second cell access information comprise measurements of a synchronization signal block or a reference signal associated with the second mode.

19. The method of claim 11, comprising sending a request to receive the second cell access information associated with the second mode.

20. The method of claim 11, wherein sending the information indicating that the second mode can be used comprises sending a request to switch from the first mode to the second mode, and the method further comprises receiving an indication, from the network node, to switch the access to the cell to the second mode.
